(19) United States
(12) Patent Application Publication
(10) Pub. No.: US 2003/0046216 A1
(43) Pub. Date: Mar. 6, 2003

(54) Method for the online auctioning of multiple items

(76) Inventor: James A. Kaplan, Encino, CA (US)

Correspondence Address: James A. Kaplan, 16705 Huerta Road, Encino, CA, 91436, US

(21) Appl. No.: 09/947,884

(22) Filed: Sep. 6, 2001

(51) Int. Cl. G06F 17/60

(52) U.S. Cl. 705/37

(57) ABSTRACT

A method for the auctioning of a multiple number of substantially similar items to a number of individual bidders including the following steps. Providing an indication of the number of substantially similar items available for auction, the minimum selling price for each item and a closing time for the auction. Receiving Individual bids from the bidders above the minimum and with each bid recorded and tabulated. At the closing time of the auction, comparing the number of bids with the number of available items and if more than the available items then the excess lowest bids are discarded and if less than the available items then all the bids are counted to provide a number of winning bids equal to or less than the available items. Determining the final selling price for all winning bidders to be the lowest winning bid received from a bidder

### BACKGROUND OF THE INVENTION

Online auctions have become a way of selling both new and used merchandise to a broad number of individuals. The success of online auctions has stimulated other industries to look at online auctioning as a method for selling goods and services to the general public. Specifically, it would be desirable to use online auctioning for the Hotel and Travel industries. Typically both of these industries have numerous like items that they would like to sell in individual lots but do so more than one at a time. For example, this could be multiple room days, cruise packages, airline tickets etc. It would be important to do this on a multiple basis since the cost of sales of such items on a one at a time basis might preclude their sale at a profit.

The current answer to this problem is to sell blocks or multiples of items that are substantially the same and can be sold at the same price. This increases the number of units sold and reduces the selling cost and provides a benefit that can be passed on to the buyer. This is accomplished by advertising special offers in which the price of an item or package can be reduced affording the buyer a pricing advantage. However, this simple method has a distinct disadvantage to the seller. While the seller is willing to sell items or packages at a lower price than the normal prices the seller does not wish to have it widely known at what price it is willing to dispose of the excess items or packages. In fact most Hotels and Airlines have elaborate computer programs allowing them to optimize their pricing according to supply and demand. Thus, by advertising a reduced price special offer, a seller can jeopardize its whole pricing structure.

What is needed is a way to sell numerous substantially similar lots at a discount but with the final price hidden from all but the ultimate buyer or buyers. This is normally done by either a closed bid auction or by what is called Dutch bid auction. The highest bidder may take any or all of the lots bid on and then successive bidders may share sequentially in the remaining items, also at the high bid. Neither of these auction methods provides hidden or opaque bidding. Also, the current auction methods do not stimulate bidding for multiple lot auctions where the seller is interested in both the price and the number of items sold at the end of the auction.

The invention described herein called a Best Shot Auction accomplishes all of these tasks in a novel and unique fashion.

### SUMMARY OF INVENTION

The present invention is directed to a method for auctioning multiple substantially similar lots in which the final price is not visible, except to the ultimate buyer or buyers, but in which bidding is stimulated by the potential for greater savings. By example, a hotel chain would like to sell multiple packages or units of five nights at the hotel. Assuming the retail value of one night at the hotel is $200, this is a total package of $1000. In fact the Hotelier may be willing to sell this package at a minimum of $100 per night or $500 if he this could be done without upsetting the whole pricing structure.

The “Best Shot Auction” system of the present provides a novel method for accomplishing the desired results using the following procedure.

An online auction is created in which the following elements exist and would be coordinated by a multipath computer program in which bids are received, controlled, sorted, Emails sent, and final notification released, via automated processing:

1. A front page containing numerous opportunities for advertising auctions of various properties or items.

2. A path to a second page which describes the item to be auctioned along with a more detailed description of the item and the number of items to be auctioned.

3. A section or page describing the Best Shot Auction rules and regulations.

4. A box showing retail value of the item and the total number of like items available for auction.

5. A box showing the minimum bid price or zero minimum if applicable.

6. A form to be completed by the bidder, containing at a minimum, Bidder identification and the Best Shot Bid.

7. After submitting the bid the bidder is automatically informed by email or other methods that the bid has been entered and accepted.

In the example, assuming there are 5 packages of 5 nights at the hotel and the final bids are750, 725, 795, 722, 728, 731 and 777. Since there are only five packages being offered the two lowest bidders are removed leaving 795,777,750,731, and 728. The winners are now informed individually by email or other method that they have purchased a 5 nights package at $728.

The winning bid price is not published or disbursed to any other parties. This protects the sellers other advertising or pricing structures. Note that four of the five bidders have actually paid less than their Best Shot Bid. Only the lowest bidder will pay what he submitted as his best bid.

### BRIEF DESCRIPTION OF THE DRAWINGS

FIG. 1 is a flow diagram of an automated auction showing the flow path and action items for a Best Shot auction;

FIG. 2 illustrates a header for an auction front page showing paths to various auction opportunities including Best Shot auctions;

FIG. 3 illustrates a Best Shot auction page including a list of potential Best Shot auction properties;

FIG. 4 illustrates a Best Shot auction detail page and advertises a specific property at auction and also includes specific details of the package being offered;

FIG. 5 illustrates a Best Shot auction bid page including a bidder form to be filled in and submitted online, and

FIG. 6 illustrates a Best Shot Auction rules page.

### DETAILED DESCRIPTION OF THE INVENTION

The present invention allows individual bidders to submit via the internet or other means a bid for one lot of a multiple lot auction. The novelty of this invention, called a Best Shot Auction, is that the winning bidder or bidders get the lot that they have bid on at the lowest price bid, not the highest price as in most auctions.

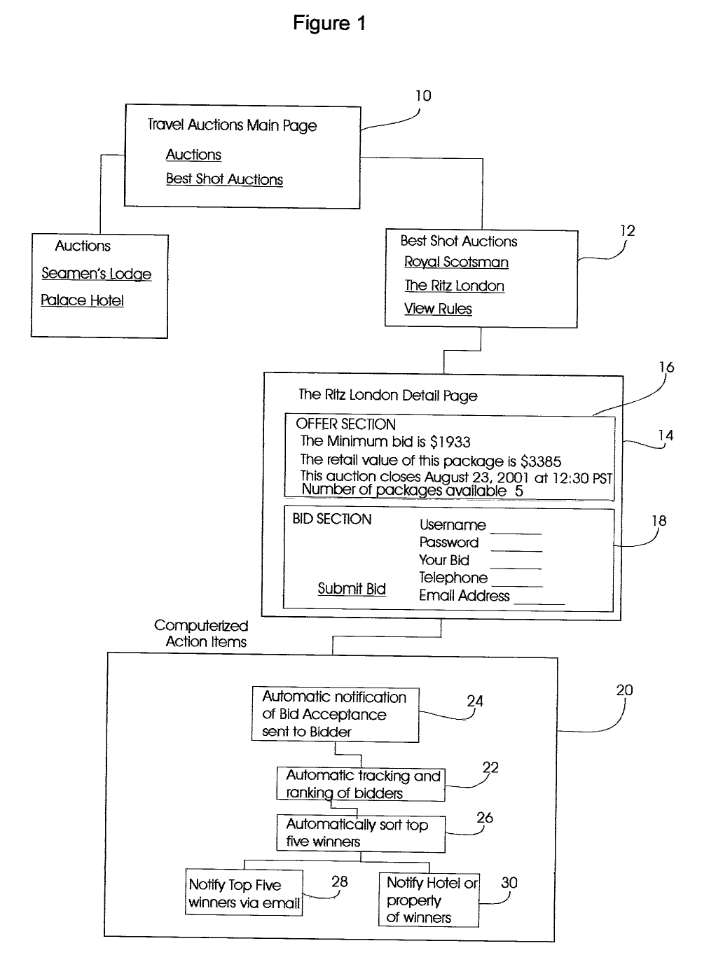

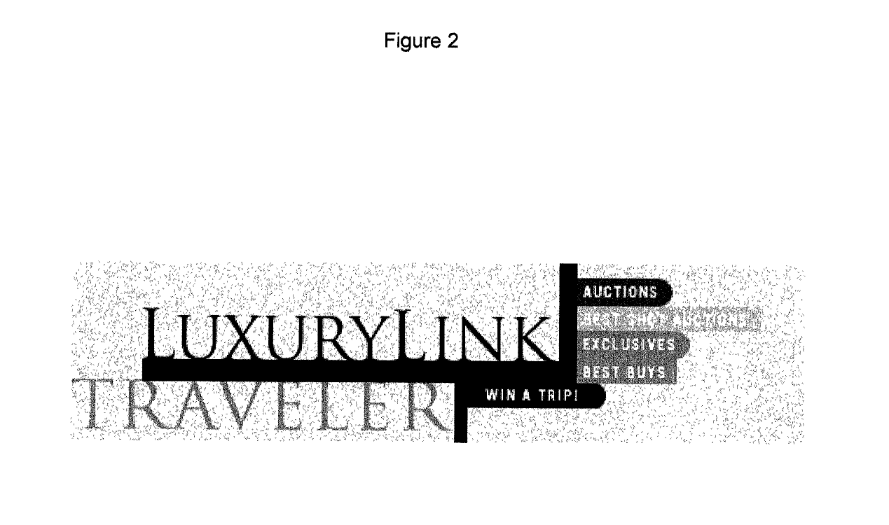

FIG. 1 is a flow diagram for the Best Shot auction of the present invention and illustrates the various steps in the method of conducting this new type of auction. As shown in FIG. 1, a potential bidder arrives at a front page for a travel internet site as represented by block 10. FIG. 2 illustrates a typical front page for the travel internet site which front page may include more than one type of auction as well as other features for the website. As shown in FIG. 2, two types of auctions are depicted, a standard high bidder auction and a Best Shot Auction. The underlined words in FIG. 1 denote an internet Hot Link which takes the bidder to the next page.

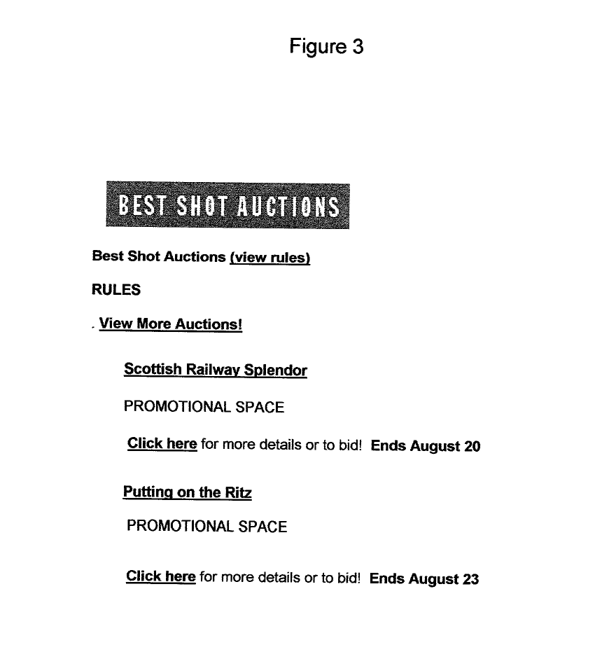

In the example shown, clicking the Best Shot Auctions button takes the potential bidder to a Best Shot Auctions block 12. An example of a Best Shot Auction page is shown in FIG. 3. This Best Shot Auction page gives a list of the current auctions available for bidding and may contain one or a multiplicity of auction opportunities. This page may also show a thumbnail photograph of the properties to be auctioned along with a brief description of the properties as shown in FIG. 3.

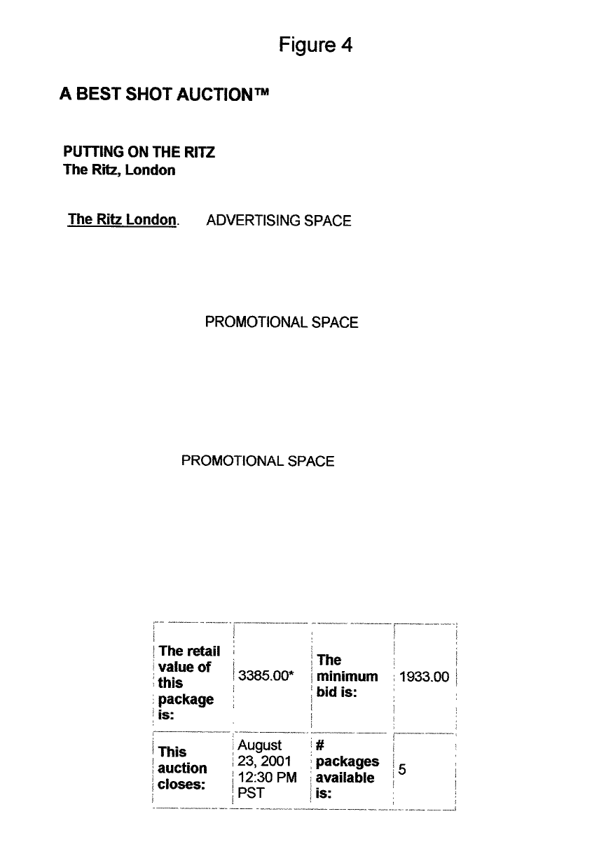

Once a potential bidder sees the opportunity he wishes to bid on he may push a “hot link”, as represented by an underlined word in block 12 to lead to a detail block 14. An example of a Best Shot Auction detail page is shown in FIG. 4. This page may include a multiplicity of photographs and a very detailed description of the property being offered for auction. This page may also include the information on the retail value, the minimum bid, the number of packages available, the auction closing time, and any other information necessary to inform the bidder of the rules of the Best Shot Auction. This detail information is also represented as portion 16 of block 24.

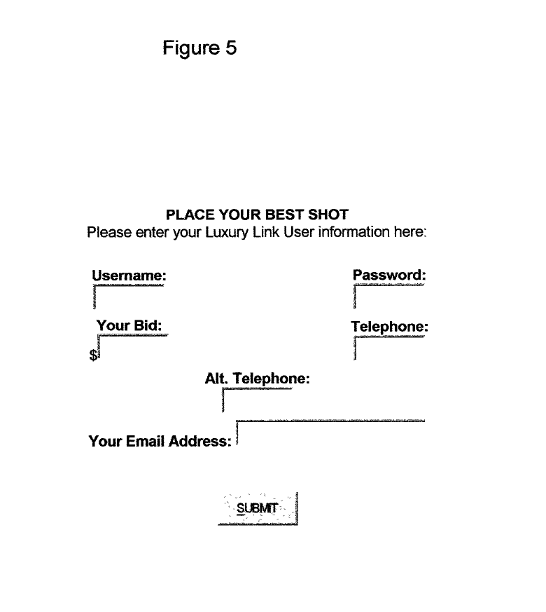

The potential bidder may now enter a bid by filling in the bid information as represented by portion 18 of block 14 and as shown by a web page illustrated in FIG. 5. Once the bid is placed it is transmitted electronic as an action item to a bid collection computer 20. The computer 20 automatically ranks the bids in the order of highest bidders as shown by block 22. An automated email response is sent to the bidder informing him that the bid has been received and accepted and that he will be notified at the close of bidding as to whether he was a successful bidder or not as shown by block 24.

At the close of bidding, the computer automatically selects the top five (in the example shown) bidders and then finds the price that the lowest of the five bidders has submitted as shown by block 26. This is the price that all winning bidders will pay for the auctioned item.

The automated program now sends congratulations email letters to all successful bidders informing them of the final price and any other pertinent information as shown by block 28. A list of winners of this auction is also supplied to the Hotel or property that was auctioned, as shown by block 30, so that further arrangements, such as date of travel etc. can be made.

It should be noted that a Best Shot auction can also be administrated manually and that while the computer generated auction is clearly a time saving feature, it is not the only method that can be used to perform the auction functions.

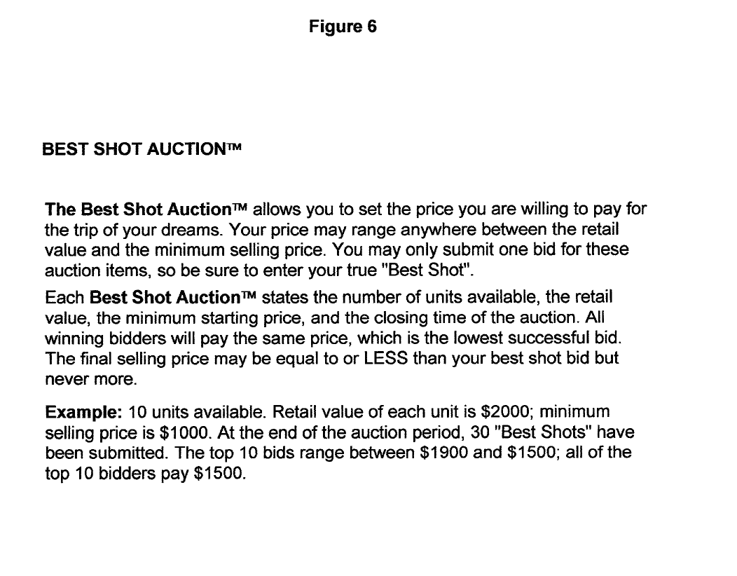

To help clarify what is the essence of a Best Shot Auction, the Best Shot Auctions rules may be chosen by a bidder to view as a web page as illustrated by FIG. 6. The access to the web page rules is in block 12 of FIG. 1 and as shown in FIG. 3.

Although the invention has been described with reference to a particular embodiment, it is to be appreciated that various modifications and adaptations may be made and the invention is only to be limited by the appended claims.

What is claimed is:

1. A method for the auctioning of a multiple number of substantially similar items to a number of individual bidders including the following steps,
an indication is provided of the number of substantially similar items available for auction, the minimum selling price for each item and a closing time for the auctions,
individual bids are received from the bidders above the minimum and with each bid recorded and tabulated,
at the closing time of the auction, the number of bids is compared with the number of available items and if more than the available items then the excess lowest bids are discarded and if less than the available items then all the bids are counted to provide a number of winning bids equal to or less than the available items,
and the final selling price for all winning bidders is determined to be the lowest winning bids received from a bidder.

2. The method of claim 1 wherein the auction is regulated by a multipath computer program in which bids are received, controlled, sorted, Emails sent, and final notifications released, via automated processing.

3. The method of claim 1 wherein the selling price is invisible to all but the successful bidder or bidders.
